(19) United States
(12) Patent Application Publication
(10) Pub. No.: US 2010/0191900 A1
(43) Pub. Date: Jul. 29, 2010

(54) NONVOLATILE MEMORY DEVICE AND METHOD OF OPERATING THE SAME

(76) Inventor: Won Sun Park, Gyeonggi-do (KR)

Correspondence Address: IP & T Law Firm PLC, 7700 Little River Turnpike, Suite 207, Annandale, VA, 22003, US

(21) Appl. No.: 12/647,276

(22) Filed: Dec. 24, 2009

(30) Foreign Application Priority Data
Jan. 29, 2009 (KR) 10-2009-0006803

(51) Int. Cl. G06F 12/02

(52) U.S. Cl. 711/103; 711/E12.008

(57) ABSTRACT

A nonvolatile memory device includes memory chips driven in response to respective chip enable signals, and each of the memory chips includes a controller configured to generate and output information about an operation state, and a state information processor configured to calculate an expected consumption current when a target operation is performed based on the information about the operation states for the memory chips, and to output a control signal regarding whether to suspend or perform the target operation.

### CROSS-REFERENCE TO RELATED APPLICATION

Priority to Korean patent application number 10-2009-0006803 filed on Jan. 29, 2009, the entire disclosure of which is incorporated by reference herein, is claimed.

### BACKGROUND

One or more embodiments relate to a nonvolatile memory device and a method of operating the same.

In recent years, there is an increasing demand for nonvolatile memory devices which can be electrically programmed and erased, and which do not require the refresh function of rewriting data at specific intervals.

The nonvolatile memory cell is configured to enable electrical program/erase operations and to perform the program and erase operations using a threshold voltage that varies when electrons are moved by applying a strong electric field to a thin oxide layer.

A nonvolatile memory device chiefly includes a memory cell array in which cells for storing data are arranged in a matrix form and a page buffer for writing data into specific cells of the memory cell array or reading data stored in a specific cell. The page buffer includes a bit line pair coupled to a specific memory cell, a register configured to temporarily store data to be written into the memory cell array or to read data stored in a specific memory cell of the memory cell array and temporarily store the read data, a sense node configured to sense the voltage level of a specific bit line or a specific register, and a bit line selection unit configured to control whether or not to couple the specific bit line to the sensing node.

Such a nonvolatile memory device includes a plurality of memory chips driven in response to different chip enable signals. In driving the plurality of memory chips, an interleaving operation for operating the memory chips at the same time within the range of a maximum permissible current assigned to the nonvolatile memory device is sought to be implemented.

### BRIEF SUMMARY

One of exemplary embodiments relate to a nonvolatile memory device designed such that as many memory chips as possible can operate within the range of a maximum permissible current of the nonvolatile memory device.

Another of the exemplary embodiments relates to a method of operating a nonvolatile memory device, which is capable of operating as many memory chips as possible using the nonvolatile memory device.

A nonvolatile memory device according to an aspect of this disclosure includes a plurality of memory chips driven in response to respective chip enable signals, and each of the memory chips includes a controller configured to generate and output information about an operation state, and a state information processor configured to calculate an expected consumption current when a target operation is performed based on the information about the operation states for the memory chips, and to output a control signal regarding whether to suspend or perform the target operation.

According to another aspect of this disclosure, there is provided a method of operating a nonvolatile memory device including a plurality of memory chips driven in response to respective chip enable signals, the method, including inputting a command for an operation of the nonvolatile memory device to a first memory chip, checking information about a target execution state of a target operation to be executed by the first memory chip in relation to the command, calculating an expected consumption current for the memory chips based on information about operation states for remaining memory chips and the information about the target execution state, comparing the expected consumption current and a maximum permissible current assigned to the nonvolatile memory device, and suspending or performing the target operation according to the comparison result.

### BRIEF DESCRIPTION OF THE DRAWINGS

FIG. 1 is a diagram showing the connection relationship between a nonvolatile memory device and a host;

FIG. 2 is a timing diagram showing the interleaving operation of the nonvolatile memory device;

FIG. 3 is a diagram showing the connection relationship between a host and a nonvolatile memory device according to an embodiment of this disclosure;

FIG. 4 is a timing diagram showing the interleaving operation of the nonvolatile memory device according to an embodiment of this disclosure;

FIG. 5 is a diagram showing the construction of each memory chip included in the nonvolatile memory device according to an embodiment of this disclosure; and

FIG. 6 is a flowchart diagram showing a method of operating the nonvolatile memory device according to an embodiment of this disclosure.

### DESCRIPTION OF EMBODIMENTS

Hereinafter, some embodiments of the present disclosure will be described in detail with reference to the accompanying drawings. The figures are provided to allow those having ordinary skill in the art to understand the scope of the embodiments of the disclosure.

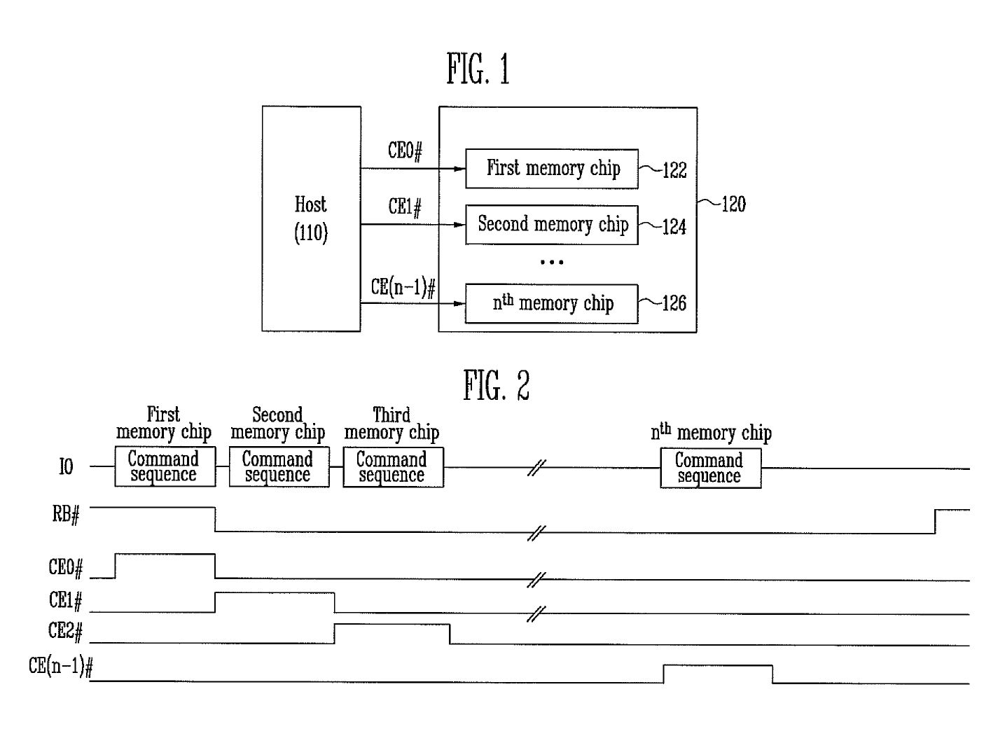

FIG. 1 is a diagram showing the connection relationship between a nonvolatile memory device and a host.

The host 110 is coupled to the nonvolatile memory device 120 and is configured to send various data, a variety of control signals (not shown), and a plurality of chip enable signals CE0# to CE(n−1)# to the nonvolatile memory device thereby driving the nonvolatile memory device. The host 110 is further configured to write external data into the nonvolatile memory device or to read data stored in the nonvolatile memory device.

The nonvolatile memory device 120 includes a plurality of memory chips 122, 124 . . . 126 that are driven in synchronization with respective chip enable signals CE#, CE1# . . . CE(n−1)#. Each of the memory chips includes nonvolatile memory (not shown), a processor (not shown), etc. The processor is configured to receive a variety of commands and data, received through an IO pad, in addition to the chip enable signal, and to perform a program operation, a read operation, an erase operation, and so on.

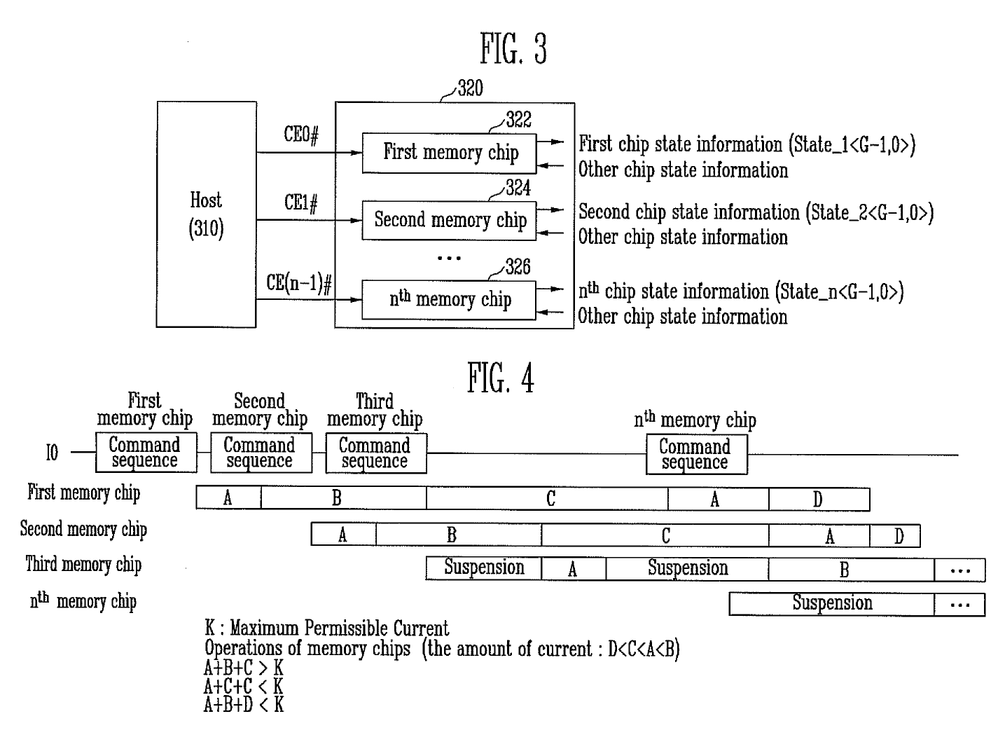

FIG. 2 is a timing diagram showing the interleaving operation of the nonvolatile memory device.

The memory chips included in the nonvolatile memory device 120 can be independently driven in response to the respective chip enable signals.

Command sequences to be applied to the respective memory chips are sequentially inputted through the host 110. Various commands, such as a program command, a read command, and an erase command, can be inputted. When the commands are inputted, the chip enable signals driving the respective memory chips are sequentially activated.

That is, the first chip enable signal CE0# driving the first memory chip 122 shifts to a high level, and thus, is activated. In synchronization with the activation, a ready busy bar signal RB# also shifts to a high level, and thus, is activated as well. When the first chip enable signal CE0# is activated, the first memory chip 122 operates and performs an operation according to the inputted command sequence.

Meanwhile, as shown in the illustrated waveform diagram, before the first chip enable signal CE0# shifts to a high level, the second chip enable signal CE1# driving the second memory chip 124 shifts to a low level, and thus, is deactivated. As described above, an operation for operating the other memory chips before the operation of one memory chip is terminated is called a chip interleaving operation. Ideally, an n number of memory chips included in the nonvolatile memory device 120 can be configured to operate at the same time. That is, ideally the total n number of memory chips can be driven at the same time by activating all chip enable signals for all the memory chips.

However, there is a case in which the host 110 using the nonvolatile memory device 120 can have a limited electric power. In particular, when considering that the nonvolatile memory device 120 is chiefly used in portable devices, such as notebooks and MP3 players, the host 110 has a limited electric power, such as a portable battery. In this case, a chip driving method according to the chip interleaving method may require more electric power than that which can be supplied by the host 110. In the worst case, the entire host system may be shut down in order to drive the nonvolatile memory device 120.

FIG. 3 is a diagram showing the connection relationship between a host and a nonvolatile memory device according to an embodiment of this disclosure.

The host 310 is coupled to the nonvolatile memory device 320 and is configured to send various data, a variety of control signals (not shown), and a plurality of chip enable signals CE0# to CE(n−1)# to the nonvolatile memory device thereby driving the nonvolatile memory device. The host 310 is further configured to write external data into the nonvolatile memory device or to read data stored in the nonvolatile memory device.

The nonvolatile memory device 320 includes a plurality of memory chips 322, 324 . . . 326 that are driven in synchronization with respective chip enable signals CE0#, CE1# . . . CE(n−1)#. Each of the memory chips includes nonvolatile memory (not shown), a processor (not shown), etc. The processor is configured to receive a variety of commands and data, received through an IO pad, in addition to the chip enable signal, and to perform a program operation, a read operation, an erase operation, and so on.

In this disclosure, the highest degree of overlap of memory chips in operation (i.e., interleaving) is sought by calculating a maximum permissible current assigned to the nonvolatile memory device 320 and current required to perform each operation of each of the memory chips. To this end, each of the memory chips outputs state information (State_n<G-1,0>) about an operation that is being performed, and sends the state information to other memory chips. Therefore, each of the memory chips receives state information about other memory chips.

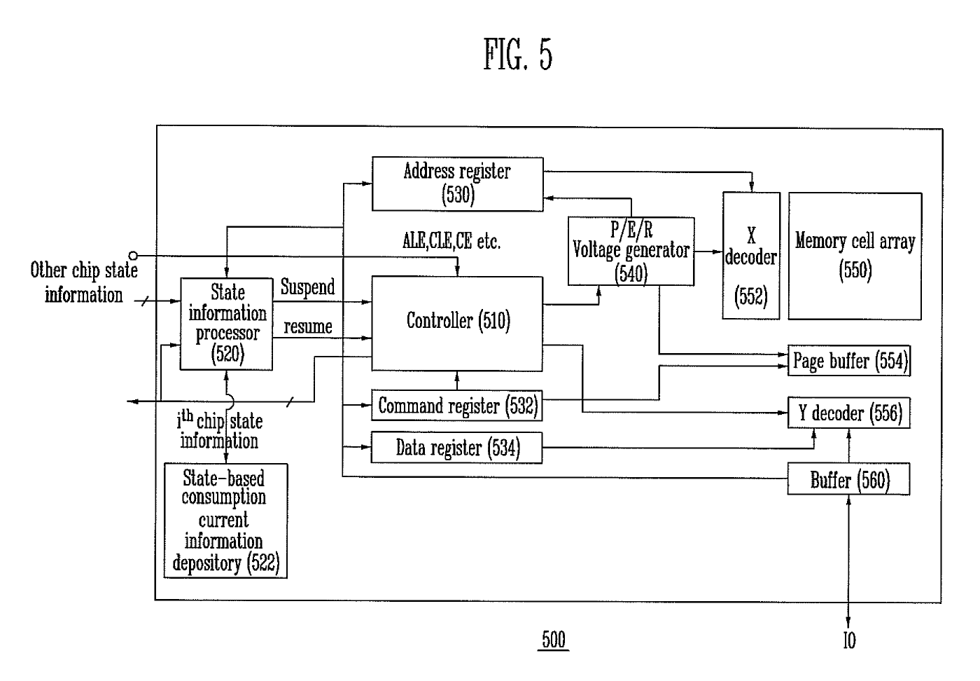

FIG. 4 is a timing diagram showing the interleaving operation of the nonvolatile memory device according to an embodiment of this disclosure.

The memory chips included in the nonvolatile memory device 320 can be independently driven in response to the respective chip enable signals.

Command sequences to be applied to the respective memory chips are sequentially inputted through the host 310. For example, a variety of commands, such as a program command, a read command, and an erase command, can be inputted.

FIG. 4 shows information about operations that are being executed on a memory-chip basis. For example, the first memory chip sequentially performs an operation A, an operation B, an operation C, an operation A, and an operation D, in that order. The second memory chip performs the same operations as the first memory chip, but does so at different times.

It is assumed that a maximum permissible current assigned to the nonvolatile memory device 320 is ‘K’. It is also assumed that the operations A, B, C, and D are performed in each of the memory chips, and that currents consumed to perform the operations A, B, C, and D decrease in order of the operations B, A, C, and D. Here, when comparing the maximum permissible current K and the amount of current consumed to perform each operation, it is assumed that the sum of the currents consumed to perform the operations A, B, and C is greater than the maximum permissible current K. Furthermore, it is assumed that the sum of the currents consumed to perform the operation A and two of the operations C is less than the maximum permissible current K. It is also assumed that the sum of the currents consumed to perform the operations A, B, and D is less than the maximum permissible current K.

In this disclosure, the operations of each memory chip are controlled by determining whether the sum of the currents consumed to perform the operations at the same time is greater than the maximum permissible current of the nonvolatile memory device.

For example, as shown in FIG. 4, it is assumed that the first memory chip is executing the operation C, while the second memory chip is executing the operation B. At that point in time, the third memory chip should perform the operation A. However, if the third memory chip performs the operation A, a total sum of the currents consumed to perform the operations at the same time would be greater than the maximum permissible current, as described above. Accordingly, the operation A of the third memory chip is temporarily suspended. Subsequently, when the operation for the second memory chip switches to the operation C, the operation A of the third memory chip starts. It is possible for the third memory chip to start operation A because the sum of the currents consumed to perform the operation A and the two operations C is less than the maximum permissible current, as described above.

In more detail, actual operations are described by example below. Assuming that a maximum permissible current assigned to a nonvolatile memory device is 200 units (the unit may be any unit of current and is not limited to any particular current unit) and the mean consumption current in each memory chip is 50 units, a total of four memory chips can be interleaved in theory. However, when considering detailed operations performed in each memory chip, the number of memory chips that can be interleaved may differ because a consumption current is different for every operation. For example, it is assumed that current of 20 units is consumed during a data IO period, current of 30 units is consumed during a pump setup period, 80 units is consumed during a cell sense period, and 10 units is consumed during other finishing periods. In this case, the number of memory chips that can perform the data IO period at the same time can be 10, and the number of memory chips that can perform the cell sense period at the same time is only 2. As described above, if a criterion of current consumed upon interleaving is based on a consumption current in each detailed operation, as opposed to the mean consumption current per memory chip, the number of permissible interleaving memory chips can be optimized. Furthermore, a phenomenon in which a host system is shut down can be prevented because periods in which the host system would otherwise shut down can be more clearly determined.

As described above, in this disclosure, memory chips are sought to be driven at the same time within the range of a maximum permissible current assigned to each memory chip by taking into consideration the operations performed in other memory chips.

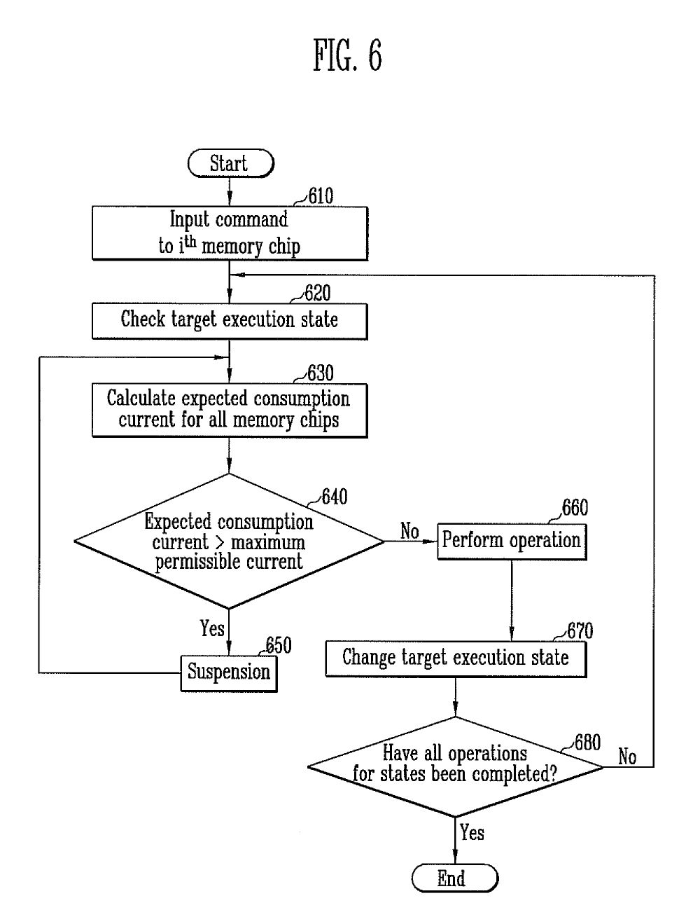

FIG. 5 is a diagram showing the construction of each memory chip included in a nonvolatile memory device according to an embodiment of this disclosure.

The memory chip 500 includes a controller 510, a state information processor 520, a state-based consumption current information depository 522, an address register 530, a command register 532, a data register 534, a high voltage generator 540, a memory cell array 550, an X decoder 552, a page buffer 554, a Y decoder 556, and a buffer 560.

The controller 510 is configured to receive a variety of external control signals ALE, CLE, CE, etc. and a command signal inputted via the buffer 560 and the command register 532, and to perform a program operation, an erase operation, a read operation, etc. in response to the command signal.

Furthermore, according to an embodiment of this disclosure, the controller 510 is configured to generate plural bits of chip state information and output them externally. The controller 510 is also configured to suspend operations that are being performed or perform suspended operations in response to a suspension control signal ‘SUSPEND’ or an operation execution control signal ‘RESUME’ outputted from the state information processor 520.

The state information processor 520 is configured to receive state information about a memory chip to which the state information processor 520 belongs from the controller 510 and state information about other memory chips from the outside. Furthermore, the state information processor 520 is configured to calculate an expected consumption current for all memory chips based on the state information, and to determine whether to suspend or continue to perform the operation by comparing the expected consumption current and a maximum permissible current assigned to the nonvolatile memory device. Further, a port for outputting the i^{th} chip state information is required.

The state-based consumption current information depository 522 is configured to store data for a variety of state-based consumption currents according to each command. The state-based consumption current information depository 522 may be configured in the form of a register or may be configured using various types of storage devices in accordance with exemplary embodiments. The state information processor 520 is configured to receive the state information about the other chips and to calculate the expected consumption current for all the memory chips with reference to the state-based consumption current information depository 522.

The address register 530, the command register 532, and the data register 534 are configured to store a variety of addresses, commands, and data received through the buffer 560. In a known nonvolatile memory device, the commands, the addresses, and the data are received through an IO port instead of the port for receiving the variety of control signals ALE, CLE, CE, etc.

The high voltage generator 540 is configured to generate and supply high voltages, such as a program voltage, a read voltage, a verification voltage, and an erase voltage, which are supplied to a memory cell, a page buffer, etc. in various operations under the control of the controller 510.

The memory cell array 550 includes a plurality of memory cells arranged in matrix form. Data are stored in each of the memory cells, and data stored in each memory cell are read. The X decoder 552 and the Y decoder 556 are used to select a memory cell on which an operation will be performed based on a row direction address and a column direction address of the memory cell.

The page buffer 554 is configured to temporarily store data to be stored in each memory cell or temporarily store data read from each memory cell when a program operation is performed.

A detailed method of operating the memory chip is described below.

FIG. 6 is a flowchart diagram showing a method of operating the nonvolatile memory device according to an embodiment of this disclosure.

First, a command is inputted to an i^{th} memory chip at step 610.

The command includes all commands that are used in various operations of the nonvolatile memory device in addition to commands for a program operation, an erase operation, and a read operation. It is assumed that the nonvolatile memory device includes an n number of memory chips in total, and a chip enable signal for any one of the memory chips is activated and the command is inputted to the corresponding memory chip (i.e., i^{th} memory chip).

Next, a target execution state is checked at step 620.

Operations are executed in response to the inputted command. The target execution state refers to a state of a target operation that is not now being executed, but has to be performed in the future.

Information about the target execution state can be checked through the controller 510. The controller 510 provides information about a state of an operation that is now being executed. In other words, the controller 510 does not provide information about the target execution state (n^{th} state), but provides information about a state ((n−1)^{th} state) of an operation that is now being executed. Accordingly, information about a state of the target operation (i.e., the target execution state) that has to be executed in the future can be checked based on the information about the state of an operation that is now being executed.

For example, a typical read operation can be classified into a period in which a pump circuit included in a memory chip is turned on and reset (a first state), a period in which a global word line GWL is precharged (a second state), a period in which a variety of high voltages are applied to each of the memory cells (a third state), a period in which a word line, a pump, etc. are discharged (a fourth state), a period in which sensed data are outputted from a page buffer to the outside (a fifth state), and an idle period (a sixth state).

When a read command is inputted for the first time, a target execution state will become the first state. Further, target execution states are sequentially increased according to subsequent operations.

Next, an expected consumption current for all the memory chips is calculated at step 630.

To this end, information about the states of the operations that are now being executed in the remaining memory chips is received, and an expected consumption current for the remaining memory chips is calculated with reference to the state-based consumption current information depository 522. Here, the information about the states of the operations that are now being executed in the remaining memory chips, other than in the i^{th} memory chip, is received from outside the i^{th} memory chip, consumption currents of the remaining memory chips are added based on the state information, and the expected consumption current of all the memory chips is calculated based on the information about the target execution state for the i^{th} memory chip that has been checked at step 620.

That is, the expected consumption current of all the memory chips is the sum of the consumption current corresponding to the target execution state of the i^{th} memory chip and the added consumption current of the remaining memory chips.

Next, the expected consumption current calculated at step 630 is compared with the maximum permissible current assigned to the nonvolatile memory device including the memory chips at step 640.

If, as a result of the comparison, the expected consumption current is determined to exceed the maximum permissible current, the target operation is suspended without being executed at step 650.

That is, where the currents consumed by the remaining memory chips and the current that will be consumed by the target operation to be executed in the i^{th} memory chip are added and the sum is more than the maximum permissible current, the target operation to be executed in the i^{th} memory chip is suspended without being executed. To this end, the state information processor 520 outputs the suspension control signal to the controller 510, and the controller 510 suspends the target operation represented by the target execution state in response to the suspension control signal.

If, as a result of the comparison at step 640, the expected consumption current is determined to be equal to or less than the maximum permissible current, the target operation is executed at step 660.

In some embodiments, where the expected consumption current is equal to the maximum permissible current, the target operation may not be executed, but rather, is suspended as in step 650.

However, in accordance with step 660 of FIG. 6, where the currents consumed by the remaining memory chips and the current that will be consumed by the target operation to be executed in the i^{th} memory chip are added and the sum is equal to or less than the maximum permissible current, the target operation to be executed in the i^{th} memory chip is executed. To this end, the state information processor 520 outputs the operation execution control signal to the controller 510, and the controller 510 performs the target operation in response to the operation execution control signal.

Furthermore, the controller 510 generates information about states of operations that are now being executed, and supplies the information to the remaining memory chips and the state information processor 520. The state information processor 520 checks information about the target execution state based on the information about the states of operations that are now being executed, which is supplied from the controller. Furthermore, each of state information processors included in the remaining memory chips can also calculate the sum of the consumption currents of all the memory chips with reference to the state information that is supplied from the controller 510 of the i^{th} memory chip.

Next, a target execution state is changed at step 670.

That is, a state subsequent to the state checked at step 620 becomes a subject state to be checked. For example, if an operation, corresponding to a state representing a period in which a pump circuit included in the memory chip is turned on and reset (a first state), is performed, then a state representing a period in which a global word line GWL (i.e., a subsequent period) is precharged (a second state) becomes a target execution state.

The above steps are repeatedly performed until all states necessary to perform the command are executed at step 680.

When a command for the read operation is received, the steps 620 to 680 are repeatedly performed until the first to sixth states, as described above, are all executed.

As described above, as many memory chips as possible are operated in consideration of the range of a maximum permissible current assigned to a nonvolatile memory device. Thus, the amount of current consumed to perform the nonvolatile memory device can be optimized. Accordingly, there is an advantage in that power supply means for portable devices, including nonvolatile memory devices, can be stably operated.

What is claimed is:

1. A nonvolatile memory device comprising a plurality of memory chips driven in response to respective chip enable signals, wherein each of the memory chips comprises:
a controller configured to generate and output information about an operation state; and
a state information processor configured to calculate an expected consumption current when a target operation is performed based on the information about the operation states for the memory chips, and to output a control signal regarding whether to suspend or perform the target operation.

2. The nonvolatile memory device of claim 1, wherein each of the memory chips further comprises a state-based consumption current information depository configured to store data for various state-based consumption currents according to commands.

3. The nonvolatile memory device of claim 1, wherein the state information processor is configured to check a target execution state of the target operation based on the information about the operation state for a memory chip, including the state information processor.

4. The nonvolatile memory device of claim 1, wherein the state information processor is configured to add a consumption current for a target execution state of a memory chip, including the state information processor, and currents currently consumed by remaining memory chips to determine an added current, and to compare the added current and a maximum permissible current assigned to the nonvolatile memory device.

5. The nonvolatile memory device of claim 1, wherein, the state information processor is configured to output the control signal to suspend the target operation, if a consumption current for a target execution state of a memory chip, including the state information processor, and the currents that are currently consumed by remaining memory chips are added to determine an added current, and the added current exceeds a maximum permissible current assigned to the nonvolatile memory device.

6. The nonvolatile memory device of claim 1, wherein, the state information processor is configured to output the control signal to perform the target operation, if a current consumption current for a target execution state of a memory chip, including the state information processor, and currents that are currently consumed by remaining memory chips are added to determine an added current, and the added current is equal to or less than a maximum permissible current assigned to the nonvolatile memory device.

7. A method of operating a nonvolatile memory device comprising a plurality of memory chips driven in response to respective chip enable signals, the method comprising:
inputting a command for an operation of the nonvolatile memory device to a first memory chip;
checking information about a target execution state of a target operation to be executed by the first memory chip in relation to the command;
calculating an expected consumption current for the memory chips based on information about operation states for remaining memory chips and the information about the target execution state;
comparing the expected consumption current and a maximum permissible current assigned to the nonvolatile memory device; and
suspending or performing the target operation according to the comparison result.

8. The method of claim 7, wherein the checking of the information about the target execution state of the target operation to be executed by the first memory chip in relation to the command includes checking the target execution state based on information about a operation state, which is received from a controller.

9. The method of claim 7, wherein the calculating of the expected consumption current includes adding consumption currents of the remaining memory chips, based on the information about the operation states, and a consumption current for the target execution state.

10. The method of claim 7, wherein the suspending or performing of the target operation according to the comparison result includes:
suspending the target operation, if the expected consumption current exceeds the maximum permissible current assigned to the nonvolatile memory device, and
performing the target operation, if the expected consumption current is equal to or less than the maximum permissible current assigned to the nonvolatile memory device.

11. The method of claim 7, wherein the suspending or performing of the target operation according to the comparison result includes:
outputting a first control signal to a controller to suspend the target operation, if the calculated expected consumption current exceeds the maximum permissible current assigned to the nonvolatile memory device, and
outputting a second control signal to the controller to perform the target operation, if the calculated expected consumption current is equal to or less than the maximum permissible current assigned to the nonvolatile memory device.

12. The method of claim 7, further comprising, changing the target execution state to a state to be executed after the target execution state, if the target operation is performed according to the comparison result.

13. The method of claim 7, wherein until the target operation to be executed by the first memory chip in relation to the command is completed, the checking of the information about the target execution state of the target operation to be executed by the first memory chip in relation to the command, the calculating of the expected consumption current for the memory chips based on information about the operation states for the remaining memory chips and the information about the target execution state, the comparing of the expected consumption current and the maximum permissible current assigned to the nonvolatile memory device, and the suspending or performing of the target operation according to the comparison result are repeatedly performed.
